(19) United States
(12) Patent Application Publication
(10) Pub. No.: US 2017/0097442 A1
(43) Pub. Date: Apr. 6, 2017

(54) PROTECTIVE COVER AND RELATED METHOD

(71) Applicant: CGG SERVICES SAS, Massy Cedex (FR)

(72) Inventor: Raphael MACQUIN, Montrouge (FR)

(21) Appl. No.: 15/312,984

(22) PCT Filed: Jun. 2, 2015
(86) PCT No.: PCT/IB2015/001057

§ 371 Date: Nov. 21, 2016

Related U.S. Application Data
(60) Provisional application No. 62/008,623, filed on Jun. 6, 2014.

(51) Int. Cl. G01V 13/00; G01V 1/20

(52) U.S. Cl. CPC G01V 13/00; G01V 1/201

(57) ABSTRACT

Covers and methods to protect outer surfaces of marine equipment are provided. The covers are manufactured to extend along at least one dimension. The covers may have antifouling properties due to the thread used to manufacture the covers or due to treatment applied to the covers after manufacturing. The covers are removably mounted on one or more pieces of marine survey equipment, without employing fastening mechanisms.

### CROSS REFERENCE TO RELATED APPLICATIONS

This application claims priority and benefit from U.S. Provisional Patent Application No. 62/008,623, filed Jun. 6, 2014, for “Antifouling Cover and Related Method,” the content of which is incorporated in its entirety herein by reference.

### BACKGROUND

Technical Field

Embodiments of the subject matter disclosed herein generally relate to devices and methods for protecting marine equipment, and more specifically to using covers that are manufactured from a thread such that to allow an elastic extension along at least one dimension.

Discussion Of The Background

Marine seismic surveys are used in the oil and gas industry to explore geological structure under the seafloor, potentially locating hydrocarbon deposits (such as oil and natural gas reservoirs). In marine seismic surveys, reflected and refracted waves emerging from under the seafloor are detected by receivers distributed along cables (known as streamers) towed by vessels or placed on the seafloor. The marine survey equipment (e.g., streamers and steering devices, weights, ropes, buoys, etc.), which is deployed in water for long periods of time, may be damaged due to tension and proliferation of microorganisms (biofouling) on its outer surface. The accumulated biofouling can obscure the reflected and refracted waves and significantly increase drag. The rate of accumulation and the impact of biofouling and other contaminants depend on factors such as geographic location, water temperature, and season. The gooseneck barnacle is the most common biofouling organism found on marine equipment.

To diminish biofouling, consideration has been given to manufacturing streamers with a permanent outer layer that has antifouling properties (as disclosed, for example, in U.S. Pat. No. 7,835,222, U.S. Patent Application Publication No. 2010/0020644 and U.S. Patent Application Publication No. 2011/0174207, the entire contents of which are incorporated herein by reference). However, when the permanent outer layer with antifouling properties is damaged (e.g., mechanically or worn out) and higher roughness patches occur on the streamer's outside surface, biofouling increases on these patches and eventually damages the seismic receivers housed inside the streamer. Thus, although the permanent outer layer with antifouling properties may initially decrease biofouling, in time, damage makes it ineffective. It is impractical to repair or replace a damaged permanent outer layer.

Consideration has also been given to providing a streamer's removable second skin as described in U.S. Patent Application Publication No. 2014/0041450, an anti-barnacle net as described in U.S. Patent Application Publication No. 2012/0250458, an antifouling tape or substrate as described in U.S. patent application Ser. No. 14/212,058, or a pre-cut antifouling protective skin for highly fouled areas as described in U.S. patent application Ser. No. 14/194,851. The entire contents of the U.S. Patent Applications and Publications cited in this paragraph are incorporated herein by reference.

One drawback of the cited methods using removable covers is the lack of flexibility of the cover materials. One example of problems due to the lack of flexibility is that it is difficult to protect streamer portions (such as an over-molded portion or a streamer attached weight) with a larger local diameter than the diameter of the rest of the streamer.

Another drawback is that it is cumbersome (if at all possible) to protect against biofouling using the above methods on pieces of marine equipment that have complex three-dimensional configurations such as birds (i.e., devices used for steering streamers). Additionally, mounting and removing prefabricated the second skin or tape on streamers takes a relatively long time.

Accordingly, it would be desirable to provide covers and methods that overcome these problems and drawbacks, to better protect the outer surface of marine survey equipment.

### BRIEF SUMMARY OF THE INVENTION

Covers manufactured from a thread (e.g., by knitting, braiding, or weaving) for protecting outer pieces of a marine survey system, provide an improved hydrodynamic shell and elasticity, as well as being easier to mount and remove than conventional covers.

According to an embodiment, there is a method for protecting outer surfaces of marine equipment. The method includes providing a thread and manufacturing a cover for a given piece of marine equipment from the thread. The cover is manufactured to elastically extend along at least one dimension. The cover may be manufactured by knitting, braiding, and/or weaving the thread. The cover may have antifouling properties.

According to another embodiment there is a method for protecting marine equipment that includes manufacturing a cover for a given piece of marine equipment from a thread, such that to allow an elastic extension of the cover along at least one dimension. The method further includes removably mounting the cover over at least a portion of an outer surface of the given piece of marine equipment without fastening the cover.

According to yet another embodiment there is an apparatus for mounting a cover on a streamer. The apparatus includes a body configured to allow the streamer to move longitudinally there-through, and a charging device configured to house one or more donut-shaped rolls of tubular cover, which are unrolled to cover the streamer passing through the body. This tubular cover is manufactured to extend radially to accommodate a streamer portion having a larger diameter than a rest of the streamer.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a bird-eye view of a marine survey system according to an embodiment;

FIG. 2 is a vertical view of the marine survey system;

FIG. 3 is a flowchart of a method for protecting marine equipment according to an embodiment;

FIGS. 4A, 4B and 4C respectively illustrate knitted, braided, and weaved textures, respectively;

FIG. 5 illustrates unrolling of a donut-shaped rolled cover along a streamer according to an embodiment;

FIG. 6 illustrates a streamer cover according to another embodiment;

FIG. 7 is a flowchart of a method for protecting marine equipment, according to another embodiment;

FIG. 8 illustrates an apparatus for mounting a cover on a streamer according to an embodiment; and

FIG. 9 illustrates the use of an apparatus for mounting a cover on a streamer onboard a vessel, according to an embodiment.

### DETAILED DESCRIPTION

The following description of the exemplary embodiments refers to the accompanying drawings. The same reference number in different drawings identifies the same or similar elements. The following detailed description does not limit the invention. Instead, the scope of the invention is defined by the appended claims. The following embodiments are discussed using the terminology and structure of a marine survey system. However, the embodiments to be discussed next are not limited to these systems, but may be used with other equipment that is submerged (and optionally towed) for a long time and thus is subject to biofouling.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures, or characteristics may be combined in any suitable manner in one or more embodiments.

Unlike conventional methods and devices, embodiments described hereinafter start from providing not a piece of fabric (which may be tailored or may be a tape), but from providing a thread to manufacture (e.g., to knit, braid, and/or weave a cover for a given piece of marine equipment). The cover is manufactured to be able to extend along at least one dimension. These differences from conventional approaches yields advantages such as the thread is easier to transport to a location where the covers are manufactured on the marine equipment and the covers can be removed by unraveling the thread. Moreover, the covers may be manufactured to no longer need closing elements, gluing, overlapping, etc., which fastening techniques may cause smoothness problems or defects.

Further, the covers manufactured from thread may have antifouling properties due to the thread material, due to treating the thread before manufacturing the cover or due to treating the manufactured cover. The cover may be manufactured in any three dimensional configuration.

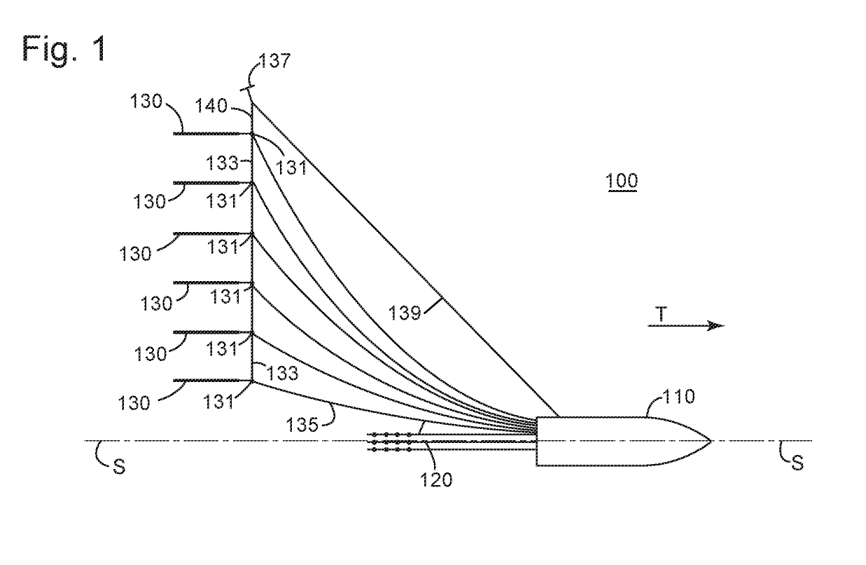

FIG. 1 is a bird-eye view of a portion of a marine survey system 100 according to an embodiment. At least one piece of the marine survey system's equipment, which is submerged for performing the survey, has an antifouling cover according to various embodiments described later. Marine survey system 100 includes a vessel 110 towing a source array 120 and streamers 130 (only half of the system up to sail-line S is shown), in direction T. Vessel 110 pulls streamers 130 via lead-in cables 135 (only two labeled in FIG. 1), which are strength members able to convey the necessary towing force. Streamers 130 are usually towed to have parallel trajectories at distances in the range of 50 and 150 m there-between. In order to achieve this streamer arrangement, a deflector 137, which is connected to vessel 110 via wide tow line 139 and to the outermost lead-in cable via a spur line 140, pulls the streamers laterally relative to the towing direction T. At locations 131, separation ropes 133 (only two labeled in FIG. 1) are connected between lead-in cables 135 to prevent exceeding the predetermined distances. This system configuration is exemplary and not intended to be limiting.

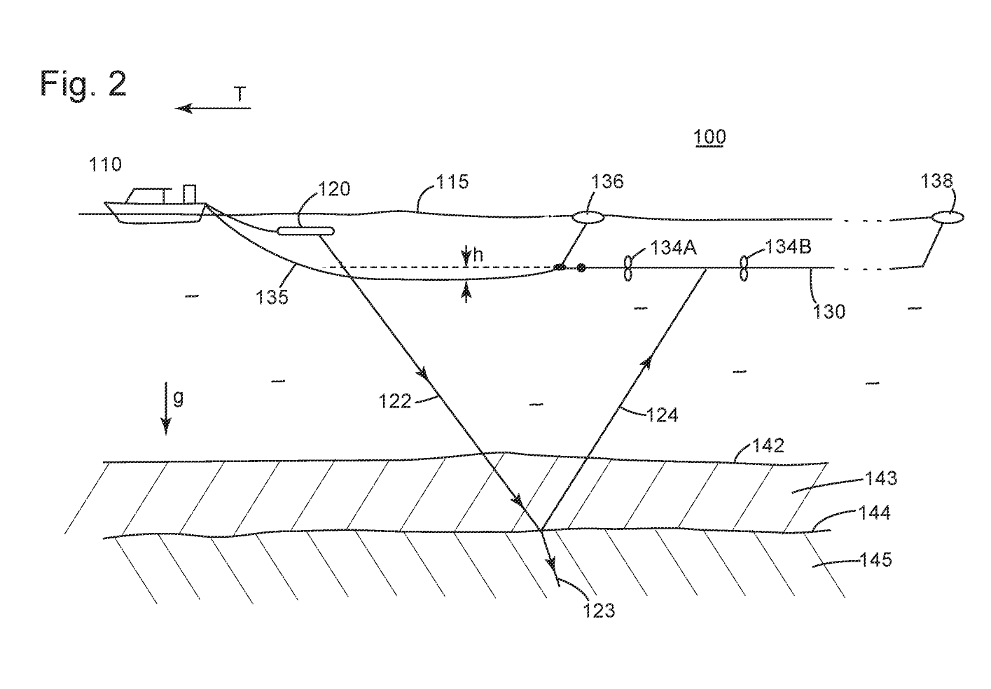

Further, FIG. 2 illustrates a vertical view (as indicated by gravity direction g) of the marine survey system 100. A float 136 may alleviate lead-in cable's 135 sagging. Due to sagging, a portion of the cable may descend at a depth h below a desired depth (an ideal cable's shape is illustrated as a horizontal dashed line in FIG. 2). Streamer 130 maintains an intended depth profile (which is parallel to water surface 115 in FIG. 2, but may also be a curved depth-varying profile) using position controlling devices 134A and 134B such as, birds, weights, etc. A tail buoy 138 may be attached to a tail end of streamer 130 for streamer profile maintaining and signaling reasons.

The manner of acquiring information regarding the geological structure under seafloor 142 is explained hereinafter based on FIG. 2. A wave 122 (e.g., a seismic or an electro-magnetic wave) generated by source array 120 penetrates seafloor 142 and is at least partially reflected at an interface 144 between a layer 143 inside which wave 122 propagates with a first velocity, and a layer 145 inside which refracted wave 123 propagates with a second velocity different from the first velocity. Reflected wave 124 travels back toward water surface 115 and is then detected by receivers carried by streamer 130.

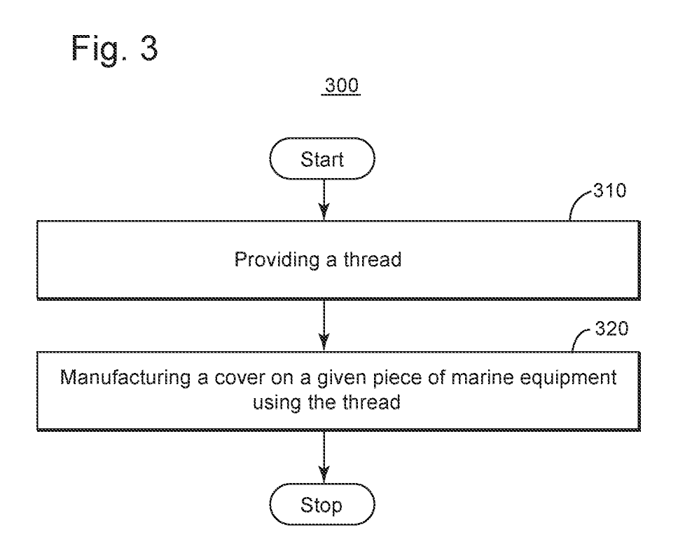

FIG. 3 is flowchart of a method 300 for protecting marine equipment from biofouling according to an exemplary embodiment. Method 300 includes providing a thread (useable to knit, braid, and/or weave), at 310. Method 300 further includes manufacturing a cover on a piece of marine equipment, using the thread, at 320.

The piece of marine equipment may be a streamer, a steering device (e.g., a bird, a deflector, etc.), ropes (e.g., lead-in cables, spur lines, separation ropes, etc.), retrievers, instrumentation (e.g., a compass), or any other submerged equipment. The cover may be manufactured by knitting braiding or weaving the thread.

In one embodiment, using elastane fibers (commercially known as Spandex or Lycra) as the thread has yielded to a cover with even more elasticity and better wrapping around the equipment. The additional elasticity enables smoother adjustment when diameter changes and improves the hydrodynamic properties of the covered streamer.

The cover manufactured at 320 may have antifouling properties preventing or lowering the rate of accumulation of biofouling. Marine organisms may be repelled by chemical and mechanical methods. In some embodiments, the antifouling properties are due to at least an outer layer of material of the thread (that is knitted, braided, or weaved to manufacture the cover). For example, the thread may be made of silicon, fluoropolymer, and any other material whose outer surface has a low surface energy. Alternatively, the thread may have a core made of thermoplastic (e.g., polyester, polyurethane, polyamide, etc.) and a coating (i.e., outer layer) of silicon, fluoropolymer, an organisms-repelling nanocoating or a coating including biocide or repulsive component through its matrix. In this case, the core gives the thread rigidity and the coating provides the antifouling properties. The thread may also be manufactured to have a reflective outer surface.

The antifouling properties may be due to chemical substances known to repel marine organisms. For example, the thread may be made of a material including a biocide substance effective against algae and barnacle cyprids (e.g., tralopyril, medetomidine, copper, avermectine, tambjamine, capsaïcine, bromed furanone, heparin, etc.). In another example, the thread may be treated with enzymes such as subtilisin (which has commercial name alcalase) that degrades barnacle cement. The biocide substances may be mixed into the thread material or applied as a coating.

It has been observed that barnacles do not attach to areas of covers where algae grow (these areas being far smoother and thinner than the areas where barnacles grow). The covers may then be manufactured to favor trapping the algae thereby preventing barnacle growth. In view of algae's antifouling effects, in one embodiment, cover(s) may be treated with an algae solution, before mounting it(them) on the equipment or before deploying the equipment in the water.

The antifouling properties may be the result of activities taking place after the cover has been manufactured. For example, a coating may be applied to a cover made of a thermoplastic thread. The coating may include the same components as discussed above for the thread. After manufacturing, the cover may (alternatively or additionally) be soaked in a solution including biocide or other antifouling substances (to cover or to penetrate inside the thread for slower release).

If the cover is manufactured by weaving, the thread may be weaved into a wrap made of threads with antifouling properties. Similarly, if the cover is manufactured by braiding two or more types of threads, only some threads may provide the antifouling properties. Two types of threads (only some which provide the antifouling properties) may also be used in knitting.

In another embodiment, the thread includes an acoustic fiber (e.g., a thread based on PVDF—polyvinylidene difluoride—and Indium) and the cover is able to vibrate at ultrasonic frequencies (e.g., 20-25 kHz) that repulse barnacle cyprids.

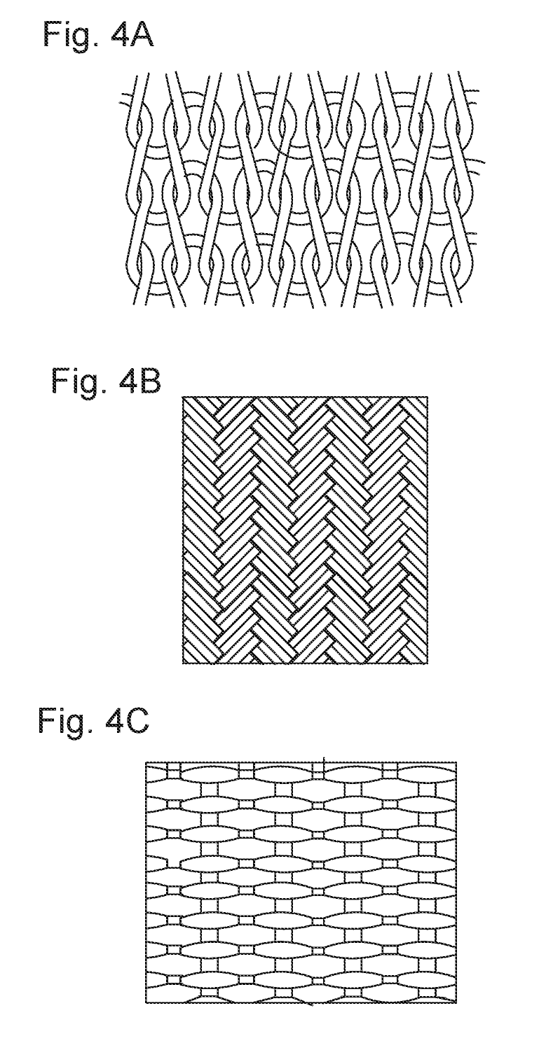

The knitted (FIG. 4A), braided (FIG. 4B), and weaved (FIG. 4C) covers have some or all the following advantages. The covers may be manufactured in any complex three dimensional configurations. The covers may have a thickness of only a few micrometers and may be manufactured to avoid having overlapping layers of the cover material. In one embodiment, the cover is manufactured around the piece of equipment. The covers may have structures on an outer surface thereof that streamline water flow around the piece of equipment, thereby reducing drag and/or cable vibration due to vortex shedding (commonly known as cable strum) to enhance the equipment's stability and lower fuel consumption for towing the marine equipment.

The covers manufactured by knitting, braiding or weaving have the advantage to be able to generate an elastic structure (cover) even with a rigid thread. The cover may be manufactured to have one or more dimensions slightly smaller than those of the piece of equipment it is manufactured to protect, and then the structure's elasticity is used when mounting it. This way, due to resulting friction between the cover and the outer surface of the equipment, the cover is prevented (once mounted) from sliding relative to the piece of equipment. The cover may be manufactured only shortly before deploying the given piece of marine equipment in the water, e.g., on the deck of the towing vessel.

Another advantage is that covers manufactured by knitting, braiding, or weaving are less likely to trap air-bubbles between the equipment and the cover. The presence of covers also reduces flow-recirculating areas where barnacle tends to attach first. Additionally, the cover may be removed by unraveling the thread.

Another advantage of the claimed methods is that a cover used for a substantially tubular piece of equipment (e.g., a streamer or a cable) may be manufactured without predefining the length of the cover. While manufactured or thereafter, a tubular structure may be rolled in a toroid (donut) shape. This shape is merely an example and it is not intended to be exclusive.

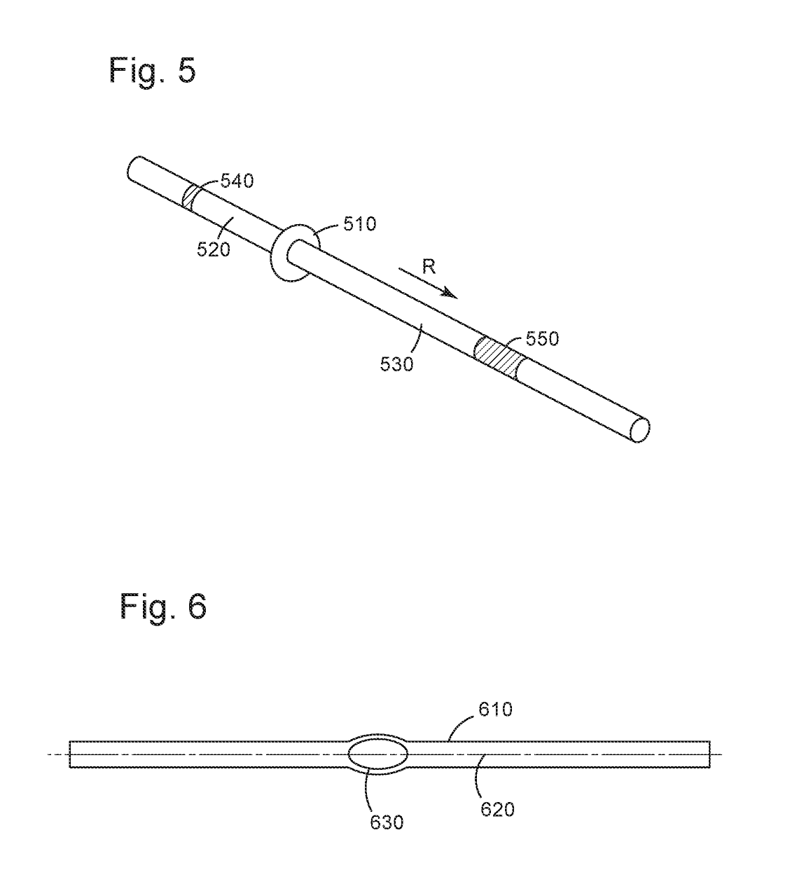

The tubular structure on a roll may be many kilometers long. As illustrated in FIG. 5, the rolled structure 510 is then unrolled along the substantially tubular piece of equipment as suggested by arrow R. In FIG. 5, portion 520 is covered by the tubular structure, while portion 530 is not yet covered. Once the end (longitudinally) of the piece of equipment is reached, the tubular structure may be cut transversely. Note that no longitudinal fastener is necessary.

The cover is be manufactured such that to allow elastic extension in at least one direction. For example, as illustrated in FIG. 6, cover 610 disposed outside a substantially tubular piece of equipment 620 extends radially to accommodate weight 630 that causes a larger local diameter than the rest of the equipment 620.

In some embodiments, the cover may be affixed to the piece of equipment to prevent a relative motion while the equipment is towed. For example, returning now to FIG. 5, a collar 540 may be mounted over the cover. In another example, glue or other adhesive may be applied between the piece of equipment and the cover (e.g., portion 550 in FIG. 5). Other affixing means may be employed to prevent the motion of the cover relative to the piece of equipment while the equipment is deployed (i.e., submerged and towed). Preferably, the affixing means are easily removable. Thus, method 300 may further include mounting the cover on the at least one piece of equipment and affixing the cover to the given piece of equipment.

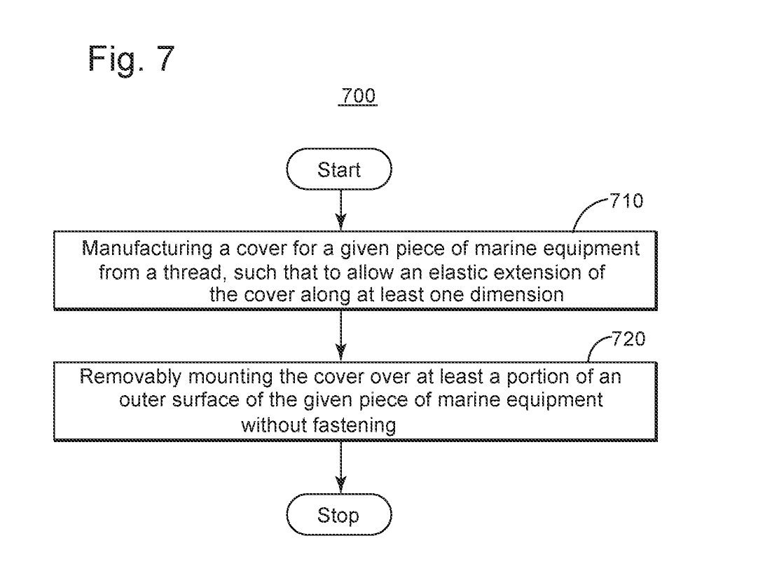

FIG. 7 is a flowchart of a method 700 for protecting marine equipment from biofouling. Method 700 includes manufacturing from a thread, a cover configured to protect a given piece of marine equipment at 710. The cover is manufactured such that to allow an elastic extension of the cover along at least one dimension. Method 700 further includes removably mounting the cover over at least a portion of an outer surface of the given piece of marine equipment, without employing any fastening mechanism, at 720. The cover may be manufactured by knitting, braiding or weaving the thread. This mounted cover may have antifouling properties.

Method 700 may further include affixing the cover to maintain its position relative to the piece of marine equipment it protects. In one embodiment, the piece of marine equipment has a substantially tubular shape and the cover is affixed to the piece of equipment using a collar. The cover may also be configured to extend radially to accommodate a portion having a larger diameter than a rest of the substantially tubular piece of marine equipment. The piece of marine equipment may be a streamer.

Method 700 may further include removing the cover when a predetermined condition is met, by unraveling the thread. The predetermined condition may include one or more of: (A) the piece of equipment is retrieved from water, (B) a predetermined period of deployment has elapsed (e.g., because it is estimated that the biofouling properties have diminished significantly), (C) visual inspection indicates accumulation of fouling on the cover or that the cover was damaged, etc. The cover may be manufactured from two or more layers.

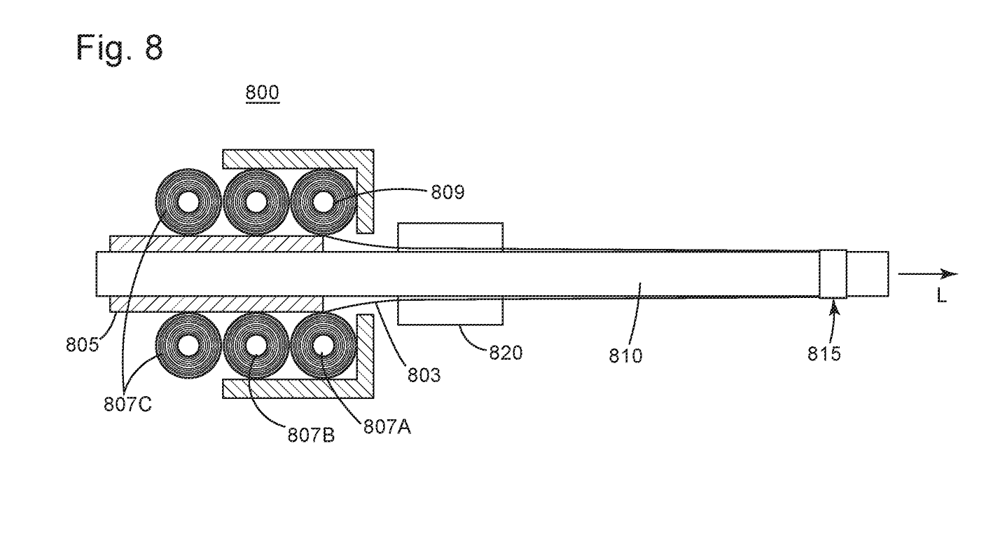

FIG. 8 illustrates a longitudinal cross-section of an apparatus 800 for mounting a cover 803 on a streamer 810. Apparatus 800 has a body 805 configured to allow streamer 810 to move there-through, in longitudinal direction L. Apparatus 800 also has a charging device 809 configured to house one or more donut-shaped rolls (807A, 807B, and 807C) of tubular cover, which is unrolled to cover streamer 810 passing through body 805. Donut-shaped rolls 807A-C actually surround the streamer, and thus, appear in this longitudinal cross-section view as two circular pieces, one above and one below the streamer. The tubular cover is manufactured to extend radially thereby being able to accommodate a streamer portion having a larger diameter than a rest of the streamer. Tubular cover 803 may be manufactured by knitting, braiding, or weaving and may have antifouling properties when exiting apparatus 800.

The antifouling properties of cover 803 may be due to the thread used to manufacture the cover, or may be due to a treatment applied to the cover in a treatment section 820. Treatment section 820, which is optional, may, for example, apply a coat on cover 803. A collar 815 may be mounted occasionally or at regular intervals over cover 803, to prevent the cover from sliding longitudinally relative to the streamer.

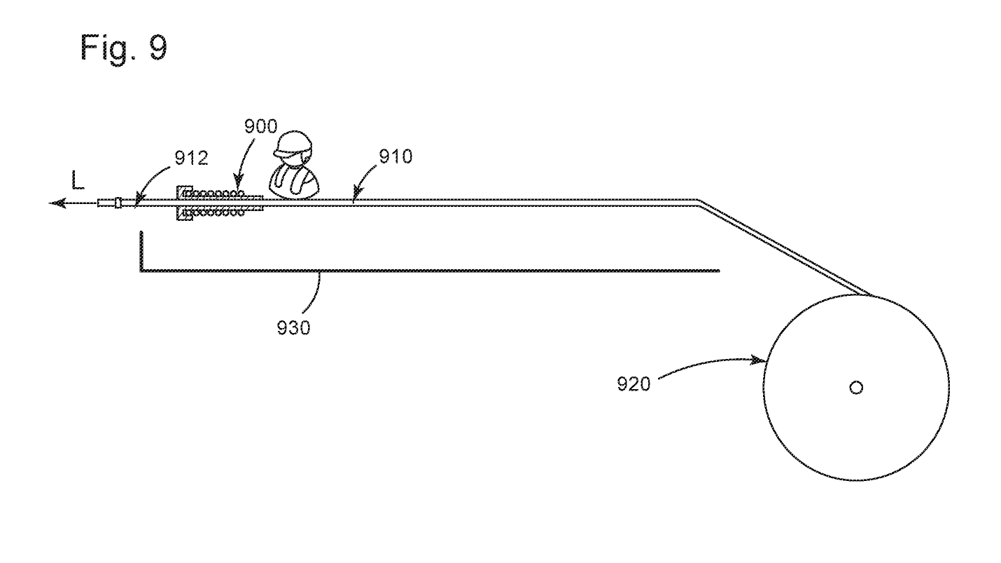

As illustrated in FIG. 9, an apparatus 900 for mounting a cover on a streamer 910 (the covered streamer is labeled 912) fed from a streamer winch 920 to be deployed (i.e., moving in direction L), may occur on streamer deck 930 of a vessel, which is part of the marine survey system. However, the cover may be mounted at any time before deploying the equipment or even manufactured on the equipment. Plural rolls including tubular covers of few tens of meters to few kilometers may be pre-stored in the charging device.

An advantage of the above embodiments is that the covers are removed with little effort, and, at the same time, any fouling deposited thereon is removed. Thus, the expense and effort to clean the pieces of marine survey equipment is substantially decreased. The covers may be cleaned and recycled onboard or later on the shore. The removal may occur each time the equipment is recovered from water, when the cover is damaged, or after observed or estimated that the antifouling properties are diminished.

The disclosed exemplary embodiments provide methods and apparatuses for protecting marine survey equipment using removable covers manufactured to allow an elastic extension of the cover along at least one dimension. It should be understood that this description is not intended to limit the invention. On the contrary, the exemplary embodiments are intended to cover alternatives, modifications, and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A method for protecting outer surfaces of marine equipment, the method comprising:
providing a thread; and
manufacturing a cover on a given piece of marine equipment using the thread, wherein the cover is manufactured such that to allow an elastic extension of the cover along at least one dimension.

2. The method of claim 1, wherein the cover is manufactured by knitting, braiding or weaving the thread.

3. The method of claim 1, wherein the cover has antifouling properties due to a material of at least an outer layer of the thread.

4. The method of claim 1, further comprising:
treating the thread to achieve antifouling properties before the manufacturing.

5. The method of claim 1, wherein the cover is manufactured to favor trapping algae thereby preventing barnacles from attaching.

6. The method of claim 1, further comprising:
treating the cover after manufacturing to achieve antifouling properties.

7. The method of claim 1, wherein the cover is manufactured shortly before deploying the given piece of marine equipment in the water.

8. The method of claim 1, wherein
an additional thread is used to manufacture the cover, and
at least one of the thread and the additional thread provides antifouling properties.

9. The method of claim 1, wherein
the cover is manufactured by weaving, and
the thread is weaved into a wrap made of threads making the cover to have the antifouling properties.

10. The method of claim 1, wherein the given piece of marine equipment includes one or more of a streamer, a steering device, a retriever, a compass, a buoy, a deflector, a rope, a lead-in cable, and a weight.

11. The method of claim 1, wherein the thread includes an acoustic fiber and the cover is able to vibrate at ultrasonic frequencies that repulse barnacle cyprids.

12. The method of claim 1, the method further comprises:
unrolling a tubular structure along the given piece of marine equipment, the tubular structure being manufactured from the thread and initially rolled in a donut shape; and
cutting the tubular structure at a predetermined length to leave the cover on the given piece of equipment.

13. A method for protecting marine equipment, the method comprising:
manufacturing a cover for a given piece of marine equipment from a thread, such that to allow an elastic extension of the cover along at least one dimension;
removably mounting the cover over at least a portion of an outer surface of the given piece of marine equipment, without fastening the cover.

14. The method of claim 13, wherein the cover is manufactured by knitting, braiding or weaving the thread.

15. The method of claim 13, further comprising:
affixing the cover to maintain a position thereof relative to the given piece of marine equipment.

16. The method of claim 13, wherein
the given piece of marine equipment has a substantially tubular shape, and
the cover is configured to extend radially to accommodate a portion having a larger diameter than a rest of the substantially tubular given piece of marine equipment.

17. The method of claim 13, further comprising:
removing the cover when a predetermined condition is met, by unraveling the thread.

18. The method of claim 13, wherein the cover is made of at least two layers.

19. An apparatus for mounting a cover on a streamer, the apparatus comprising:
a body configured to allow the streamer to move longitudinally there-through; and
a charging device configured to house one or more donut-shaped rolls of tubular cover, which are unrolled to cover the streamer passing through the body,
wherein the tubular cover is manufactured to extend radially thereby being able to accommodate a streamer portion having a larger diameter than a rest of the streamer.

20. The apparatus of claim 19, further comprising:
a treatment section configured to treat the tubular cover surrounding the streamer to achieve antifouling properties.
